(19) United States
(12) Patent Application Publication
(10) Pub. No.: US 2003/0081766 A1
(43) Pub. Date: May 1, 2003

(54) Headset for telecommunications

(75) Inventor: Maurice Quarre, Toppenstedt (DE)

Correspondence Address: Gerald H. Kiel, Esq., REED SMITH LLP, 599 Lexington Avenue, New York, NY, 10022-7650, US

(73) Assignee: Sennheiser electronic GmbH & Co. KG

(21) Appl. No.: 10/280,685

(22) Filed: Oct. 25, 2002

(30) Foreign Application Priority Data
Oct. 26, 2001 (DE) 101 52 450.1

(51) Int. Cl. H04M 1/00; H04M 9/00

(52) U.S. Cl. 379/428.01; 379/428.02

(57) ABSTRACT

A headset is provided for telecommunications. This headset generally comprises a hearing/speaking set, as it is called, with at least one ear piece and a band which is placed over the neck or head of the person telephoning. Further, the headset is outfitted with a microphone arm comprising a holder having a microphone which is arranged at the front end of the holder, that is, in direct proximity to the mouth of the person telephoning. It is the object of the invention to improve and simplify the previous solutions for professional headsets. The headset for telecommunications comprises a microphone arm with a free end on which a microphone is arranged, and wherein the audio signals received by the microphone are fed to a telecommunications device for further processing, wherein the headset has an illumination arrangement which is activated when telephoning with the headset.

### CROSS-REFERENCE TO RELATED APPLICATIONS

This application claims priority of German Application No. 101 52 450.1, filed Oct. 26, 2001, the complete disclosures of which are hereby incorporated by reference.

### BACKGROUND OF THE INVENTION

a) Field of the Invention

The invention is directed to a headset for telecommunications. This headset generally comprises a hearing/speaking set with at least one ear piece and a band which is placed over the neck or head of the telephoning person. Further, the headset is outfitted with a microphone arm comprising a holder having a microphone which is arranged at the front end of the holder, that is, in direct proximity to the mouth of the person telephoning.

This headset is connected to a telephone, so that the person telephoning need no longer hold a telephone receiver when actively telephoning, but rather has both arms free and, for example, can carry out other office activities in addition to telephoning.

The headset of the type mentioned above has been incorporated into many areas, particularly in calling centers and reception rooms, that is, wherever telephoning is the primary occupation, whether for receiving or conveying information or for performing other services by telephone.

b) Problem Addressed by the Invention

The problem occurring in the headset for telecommunications consists in that a third party entering into the vicinity of the telephoning person wearing the headset often addresses this person without knowing whether or not that person is actively telephoning at the time.

Since it is common to see an actively telephoning person also holding a receiver or mobile telephone to the ear, this generally results in very undesirable interruptions of the telephoning person wearing the headset.

For these reasons, it is also already provided for in calling centers that the telephoning person sits in his or her own cabin so as to be able to work without being disturbed. However, this solution can not be used in reception areas.

### OBJECT AND SUMMARY OF THE INVENTION

It is the primary object of the invention to avoid the disadvantages mentioned above and also to improve and simplify the previous solutions for professional headsets.

This object is met by a headset for telecommunications comprising a microphone arm with a free end on which a microphone is arranged and wherein the radio signals by the microphone are fed to a telecommunications device for further processing, the headset also having an illumination device which is arranged at the headset for telecommunications, which illumination device is activated when the headset is actively in use for telephoning.

The illumination device is preferably an LED, OLED or a filament or the like and, depending on the variant, can light in a wide variety of colors of red, green, blue, black or mixed colors.

Illumination can also be carried out in a blinking manner or in such a way that the color green lights up, for example, when no telephone conversation is taking place and no call is coming in, the color yellow lights up when a call is coming in, and the color red lights up when active telephoning is taking place.

As an alternative to the above-mentioned solution with illumination devices at the holder or band of the headset, which is held in some cases so as to be partially transparent, a connection box can also be provided between the telephone and the headset (hearing/speaking set). This connection box can have a clear or clouded window. An illumination device is arranged under the window and causes the entire window to light up when appropriately illuminated. The window itself can also carry an advertising logo.

As soon as the illumination device is activated, for example, with red illumination, a person entering the room knows that a telephone call is in progress and will behave accordingly, so that the desired aim of the invention, namely, that persons telephoning will not be unintentionally addressed by third parties, is achieved.

### BRIEF DESCRIPTION OF THE DRAWINGS

In the drawings:

FIG. 1 illustrates in pictorial representation a headset in accordance with the invention;

FIG. 2 illustrates the microphone arm of FIG. 1 in greater detail; and

FIG. 3 is a block diagram of a further variant of the present invention.

### DESCRIPTION OF THE PREFERRED EMBODIMENTS

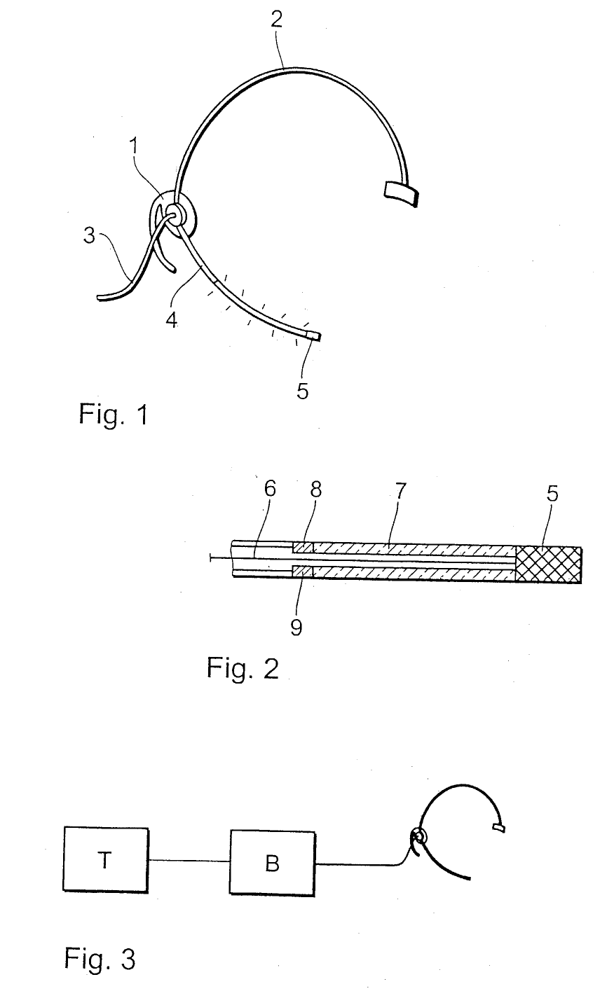

FIG. 1 shows a professional headset for telecommunications according to the invention. This headset comprises a speaker set with an ear piece 1, a band 2 which is arranged at the latter and which can be placed over the neck or head of the user in order to fix the hearing/speaking set on the head of the user. The headset is connected to a telephone (not shown) by a cord 3. Further, the headset according to the invention has a microphone arm 4. A microphone 5 is located on the front end of the microphone arm 4 and the telephoning person speaks into the microphone 5 when telephoning.

Further, an illumination device is arranged at the microphone arm and lights up when a telephone call is received and/or when a telephone call is taking place, so that a third party knows immediately whether the telephoning person can be addressed.

FIG. 2 shows the microphone arm according to FIG. 1 in more detail. The microphone is again shown at the front end. The microphone 5 is connected to the telephone by a cord 6 which runs through the holder. In the embodiment form shown in the drawing, the cord 6 is inside a tube which is itself enclosed by a transparent tube 7. Different illumination devices 8 and 9 are arranged laterally in this transparent tube 7 and cause the entire transparent tube to light up when activated. The transparency of the tube should be designed in such a way that the light is captured as much as possible within the transparent tube.

The illumination devices 8 and 9 can have different colors and are preferably constructed in such a way that they use as little electrical power as possible for illumination. The illumination devices 8 and 9 are connected by a cord to a corresponding control device which detects the status of the telephone and controls the illumination devices depending on this status.

Of course, a programming device can also be provided so that a user can program the appropriate response of the illumination devices, e.g., in such a way that the front microphone arm of the headset according to FIG. 2 lights in green when a telephone call is received and lights in red when telephoning is in progress.

Of course, third parties can be alerted appropriately also through the use of different blinking lights.

As an alternative to the headset described above, FIG. 3 shows another variant in which a box B is connected between the headset and the telephone. This box B can likewise contain illumination devices and can be set up, for example, on the work table or desk of a telephoning person, i.e., in full view. As soon as a telephone call is received or telephoning is in progress, illumination devices of the box are correspondingly activated, so that a third party entering the room knows immediately if a telephone call is in progress.

Of course, the great variety of lighting variants as described already with reference to FIG. 2 can also be verified in box B in addition to those described.

The object according to the invention can be met in an outstanding manner by the invention by generating the optical signal which shows that a person is engaged in telephoning. The optical signal indicating that a telephone call is in progress is extremely effective and, moreover, greatly adds to the cosmetic appeal of the headset.

The illumination of the microphone according to the invention also provides another decorative element, as it were, which makes the use of the headset according to the invention more attractive.

While the foregoing description and drawings represent the present invention, it will be obvious to those skilled in the art that various changes may be made therein without departing from the true spirit and scope of the present invention.

What is claimed is:

1. A headset for telecommunications comprising:
a microphone arm with a free end on which a microphone is arranged;
a telecommunications device, wherein audio signals received by said microphone are fed to said telecommunications device for further processing; and
an illumination arrangement which is activated when telephoning with the headset.

2. The headset according to claim 1, wherein the illumination arrangement comprises an LED.

3. The headset according to claim 1, wherein the illumination arrangement is formed in or on the arm.

4. The headset according to claim 1, wherein a part of the arm is illuminated by the illumination device when the headset is in active use.

5. The headset according to claim 4, wherein the front part of the arm is illuminated by the illumination device when the headset is in active use.

6. The headset for telecommunications comprising:
a microphone arm with a free end on which a microphone is arranged;
a communications device, wherein the audio signals received by the microphone are fed to said telecommunications device for further processing; and
a connection box outfitted with illumination devices which are switched on when telephoning is in progress being connected between the headset and the telephone.

7. The headset according to claim 1, wherein the illumination arrangement lights when the headset is ready for operation after its connection.

8. The headset according to claim 1, wherein the illumination arrangement generates blinking when a telephone call is received, but the conversation has not yet commenced.

9. The headset according to claim 1, wherein the illumination arrangement generates blinking when the headset is in active use in telephoning.

10. The headset according to claim 1, wherein the illumination arrangement does not light up when no call is being received, wherein the illumination arrangement blinks at predetermined time intervals when a call is received, and wherein the illumination arrangement stays lit when an active telephone call is taking place.

11. The headset according to claim 1, wherein a control device is provided for the illumination arrangement and is coupled to the telephone with which the headset is used, and wherein the control device controls the illumination arrangement in the desired manner depending on telephoning status.

12. The headset according to claim 1, wherein the headset has at least two different colored illumination devices, and wherein, for example, a green illumination device lights up when a telephone call is not being received, a yellow illumination device lights when a telephone call is being received, and a red illumination device lights up when an active telephone call is in progress with the headset.
